(19) United States
(12) Patent Application Publication
(10) Pub. No.: US 2006/0069965 A1
(43) Pub. Date: Mar. 30, 2006

(54) Data transfer device

(75) Inventor: Makoto Ito, Kasugai (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/272,682

(22) Filed: Nov. 15, 2005

Related U.S. Application Data
(63) Continuation of application No. PCT/JP03/10152, filed on Aug. 8, 2003.

(51) Int. Cl. G06F 11/00

(52) U.S. Cl. 714/100

(57) ABSTRACT

A data transfer device for seamlessly transferring data even when an error occurs during the update of a key. A data transfer device includes a transmitter for generating plural pieces of encrypted data by encrypting the same data with different keys. A receiver receives the encrypted data from the transmitter and decrypts the encrypted data. The receiver includes a switch unit for selecting one of the plural pieces of decrypted data and switches to the selected decrypted data based on a switch signal. An error detection circuit detects an error in the decrypted data selected by the switch unit and generates the switch signal when detecting an error.

### CROSS-REFERENCE TO RELATED APPLICATIONS

This application is based upon prior International Patent Application No. PCT/JP03/10152, filed Aug. 8, 2003, the entire contents of which are incorporated herein by reference.

### BACKGROUND OF THE INVENTION

The present invention relates to a data transfer device for encrypting digital data and transferring the encrypted digital data.

In recent years, when an audio/video (AV) device is connected to a system, data is often transferred to the AV device in the form of digital signals complying with standards such as IEEE 1394 and USB. The data that is transferred by such a data transfer device is copy-protected to prevent copying of the data in an unlimited manner without any deterioration. The data transfer device is required to transfer such copy-protected data in a stable manner.

Digital data that is transferred in compliance with the IEEE 1394 standard or USB standard is copy-protected in compliance with the Digital Transmission Content Protection (DTCP) Specification standard.

A transmission-side device (hereafter referred to as a “transmitter”) encrypts video data such as Moving Picture Expert Group (MPEG) data, and transmits the encrypted video data to a reception-side device (hereafter referred to as a “receiver”) via a transfer channel complying with the IEEE 1394 standard. The receiver performs authentication and key exchange with the transmitter. Upon completion of the key exchange, the receiver decrypts the encrypted data to generate video data, which is output to a video display.

The transfer operation will now be described with reference to FIG. 6. Prior to the transfer operation, a transfer channel (channel) is first set between the transmitter and the receiver (step S1). Then, the authentication operation and the key exchange are performed (step S2).

The authentication operation is an operation in which the transmitter and the receiver check each other's authenticity. The key exchange is an operation in which the transmitter and the receiver exchange a key necessary for the encryption process performed by the transmitter and a key necessary for the decryption process performed by the receiver. Subsequently, the transfer of encrypted data from the transmitter is started (step S3). During the data transfer, a channel number, which is uniquely set for each channel, is transferred with the data. The receiver having the same channel number as the transferred channel number is permitted to receive the data.

During such a transfer operation, the transmitter updates its key at time intervals of 30 seconds to 2 minutes to prevent unauthorized external access. The transmitter performs encryption based on the updated key. The odd/even bits appended to the encrypted MPEG data is changed to notify the receiver that the key has been updated. The receiver updates its key based on the update notification, and performs the decryption process based on the updated key (step S4).

When the decryption is successfully performed by the receiver based on the updated key, the operation described above is repeated until the transfer is completed (steps S3 to S5).

When at least one of the transmitter and the receiver fails to successfully update its key in step S4, the receiver cannot successfully perform the decryption process. When the transmitter and the receiver successfully update their keys during the next key update, the decryption process is resumed.

In such a case, the receiver temporarily stops providing video data to the video display apparatus. Thus, the video images shown on a display are temporarily interrupted. When the video data is MPEG data, the video images temporarily become still.

When the receiver fails to successfully perform the decryption process, the receiver may request transfer of a new key from the transmitter. In this case, the request is transmitted and received in packets. The packets containing the request occupy the corresponding bandwidth of other devices connected to a common IEEE 1394 system. This lowers the communication efficiency of the system.

Further, when the key of the transmitter is damaged, the receiver cannot successfully update its key even if the receiver requests transfer of a new key from the transmitter. In such a case, the video is successively interrupted.

It is an object of the prevent invention to provide a data transfer device that seamlessly transfers data even when a key update error occurs in the transmitter and receiver.

### SUMMARY OF THE INVENTION

One aspect of the present invention is a data transfer device for transmitting and receiving encrypted data. The data transfer device includes a transmitter for transmitting the data and a receiver for receiving the data. The transmitter and the receiver including a plurality of channels for transferring plural pieces of encrypted data that are generated by encrypting the same data using different keys and for decrypting the plural pieces of encrypted data. The receiver further includes a switch unit for selecting one of the plural pieces of decrypted data transferred via the plurality of channels and switching to the selected piece decrypted data based on a switch signal. An error detection unit detects an error in the selected decrypted data selected by the switch unit and generating the switch signal when detecting an error in the selected decrypted data.

Another aspect of the present invention is a data transfer device for transmitting and receiving encrypted data. The data transfer device includes a transmitter for transmitting the data and a receiver for receiving the data. The transmitter includes a plurality of encryption circuits for generating plural pieces of encrypted data by encrypting the same data using different keys and appending a different channel number to each piece of encrypted data. The receiver includes a distributor for distributing the plural pieces of encrypted data in accordance with the channel number. A plurality of decryption circuits generate plural pieces of decrypted data by decrypting the plural pieces of encrypted data. Each decryption circuit decrypts the corresponding encrypted data distributed by the distributor based on a key transmitted from the corresponding encryption circuit. A switch unit selects one of the plural pieces of decrypted data generated by the decryption circuits and switching to the selected decrypted data based on a switch signal. An error detection unit detects an error in the decrypted data selected by the switch unit and generates the switch signal when detecting an error.

A further aspect of the present invention is a transfer device for transmitting and receiving encrypted data. The data transfer device including a transmitter for transmitting the data and a receiver for receiving the data. The transmitter includes a first encryption circuit for encrypting data with a first key to generate first encrypted data. A second encryption circuit encrypts data with a second key to generate second encrypted data. The receiver includes a first decryption circuit for receiving the first encrypted data from the first encryption circuit and decrypting the first encrypted data with the first key to generate first decrypted data. A second decryption circuit receives the second encrypted data from the second encryption circuit and decrypts the second encrypted data with the second key to generate second decrypted data. A switch unit, connected to the first and second decryption circuits, selects one of the first decrypted data and the second decrypted data and switches to the selected decrypted data based on a switch signal. An error detection unit, connected to the switch unit, detects an error in the decrypted data selected by the switch unit and generating the switch signal when detecting an error.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of a data transfer device according to a first embodiment of the present invention;

FIG. 2 is a flowchart showing the operation of the data transfer device of FIG. 1;

FIG. 3 is a flowchart showing the operation of a video error detection circuit included in the data transfer device of FIG. 1;

FIG. 4 is a schematic block diagram of a data transfer device according to a second embodiment of the present invention;

FIG. 5 is a schematic block diagram of a data transfer device according to a third embodiment of the present invention; and

FIG. 6 is a flowchart showing the operation of data transfer between a transmission-side device and a reception-side device in a prior art example.

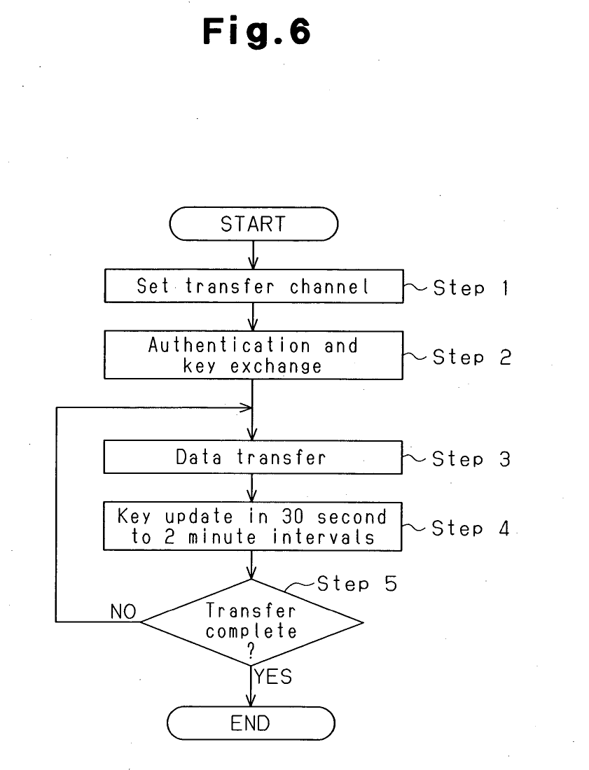

### DETAILED DESCRIPTION OF THE PREFERRED EMBODIMENTS

### First Embodiment

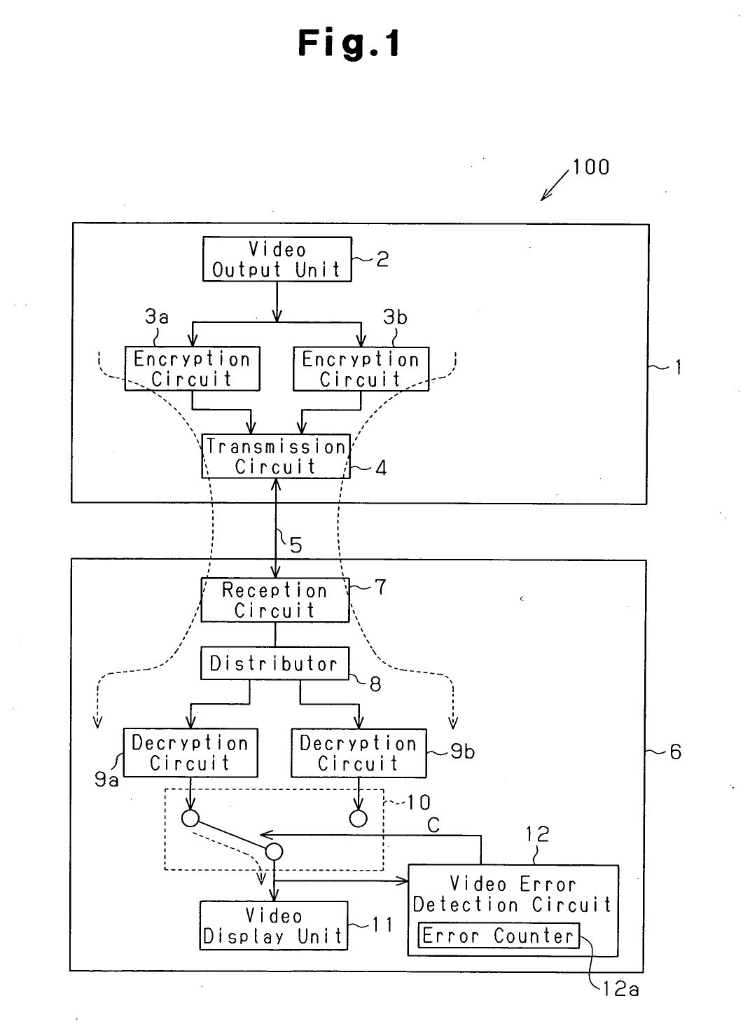

FIG. 1 shows a data transfer device 100 according to a first embodiment of the present invention. The data transfer device 100 includes a transmitter 1 and a receiver 6. The transmitter 1 may be, for example, a digital video home system (D-VHS) videocassette recorder. The transmitter 1 includes a video output unit 2, an encryption circuit 3a, an encryption circuit 3b, and a transmission circuit 4. The video output unit 2 reads video data (MPEG data in this case) from a recording medium and provides the encryption circuits 3a and 3b with the read video data.

Each of the encryption circuits 3a and 3b has a unique key, encrypts the video data based on the unique key, appends a uniquely set channel number to the encrypted video data, and the IEEE 1394 transmission circuit 4 with the encrypted video data. Further, the encryption circuits 3a and 3b update their keys at time intervals of 30 seconds to 2 minutes. Update notifications of the keys are transmitted in a state appended to the encrypted video data.

The receiver 6 may be, for example, a digital TV that is capable of receiving digital video data. The receiver 6 includes a reception circuit 7, a distributor 8, decryption circuits 9a and 9b, a video data switch unit 10, a video display unit 11, and a video error detection circuit 12. The reception circuit 7 is connected to the transmission circuit 4 by a cable 5.

The reception circuit 7 receives the encrypted data and provides the distributor 8 with the encrypted data. The distributor 8 selectively distributes the encrypted data to the decryption circuit 9a and 9b based on the channel numbers that are appended to the encrypted data.

The decryption circuit 9a performs authentication and key exchange with the encryption circuit 3a. The decryption circuit 9b performs authentication and key exchange with the encryption circuit 3b. Based on the exchanged keys, each of the decryption circuits 9a and 9b decrypts the corresponding encrypted data to generate video data and provides the switch unit 10 with the video data.

The switch unit 10 selects either the video data from the decryption circuit 9a or the video data from the decryption circuit 9b to provide the video display unit 11 and the video error detection circuit 12 with the selected video data. The video display unit 11 shows video images based on the provided video data. If the video error detection circuit 12 detects an error in the provided video data, the video error detection circuit 12 provides the switch unit 10 with a switch signal C. In response to the switch signal C, the switch unit 10 switches the decryption circuit connected to the video display unit 11.

With this configuration, video data output from the video output unit 2 is transferred via a first transfer channel including the encryption circuit 3a, the transmission circuit 4, the reception circuit 7, the distributor 8, and the decryption circuit 9a, and a second transfer channel including the encryption circuit 3b, the transmission circuit 4, the reception circuit 7, the distributor 8, and the decryption circuit 9b. In other words, the transmitter 1 and the receiver 6 have a plurality of channels for transferring plural pieces of encrypted data, which are generated by encrypting identical video data using different keys, and for decrypting the plural pieces of encrypted data. Between the transmission circuit 4 and the reception circuit 7, the encrypted data provided from the encryption circuits 3a and 3b is sequentially transmitted in predetermined packets units in compliance with the IEEE 1394 standard. Instead of the IEEE 1394 standard, the data transfer may be performed in compliance with the USB standard.

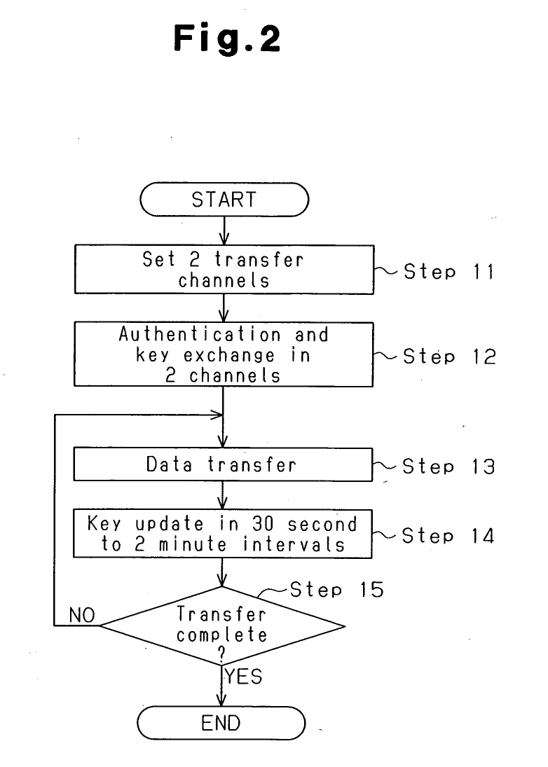

The operation of the data transfer device 100 will now be described with reference to FIG. 2.

Prior to the transfer operation, two channels, namely, first and second channels, are set between the transmitter 1 and the receiver 6 (step S11). Then, the authentication operation and the key exchange are performed in each channel (step S12).

Next, the transfer of data from the transmitter 1 to the receiver 6 is started (step S13). More specifically, video data provided from the video output unit 2 is encrypted by the encryption circuits 3a and 3b with different keys, and the encrypted data is provided to the receiver 6 via the transmission circuit 4. During the data transfer, a channel number uniquely set for each transfer channel is transferred together with the corresponding encrypted data.

In the transfer operation, each of the encryption circuits 3a and 3b updates its key at time intervals of 30 seconds to 2 minutes and performs encryption with the updated key (step S14). The key update prevents unauthorized external access. The odd/even bits appended to each piece of MPEG data encrypted by the encryption circuits 3a and 3b is changed to notify the receiver 6 that the key has been updated.

The reception circuit 7 receives the encrypted data and provides the distributor 8 with the received encrypted data. The distributor 8 selectively distributes the encrypted data to the decryption circuits 9a and 9b based on the channel numbers appended to the pieces of encrypted data. Each of the decryption circuits 9a and 9b performs the decryption process on the corresponding encrypted data while updating their keys based on the key exchange and the notification of the update of the keys (steps S13 and S14).

When, for example, the video data decrypted by the decryption circuit 9a is selected by the switch unit 10 and the selected video data is provided to the video display unit 11, the video display unit 11 shows video images based on the provided video data. At the same time, the selected video data is provided from the switch unit 10 to the video error detection circuit 12. The video error detection circuit 12 determines whether the video data is normal. When the piece of video data provided to the video display unit 11 is normal, the operation described above is repeated until the transfer is completed (steps S13 to S15).

When the decryption circuit 9a fails to successfully update its key and the decryption process is not successfully performed, the video error detection circuit 12 detects an error in the video data in step S13. In this case, the video error detection circuit 12 provides the switch unit 10 with a switch signal C. Based on the switch signal C, the decryption circuit 9b is newly connected to the video display unit 11. Therefore, the video display unit 11 shows video images based on the video data provided from the decryption circuit 9b. The decryption circuit 9a updates its key based on the next notification of the key update. When the decryption circuit 9a successfully updates the key, the decryption circuit 9a recovers to the state in which normal decryption is enabled.

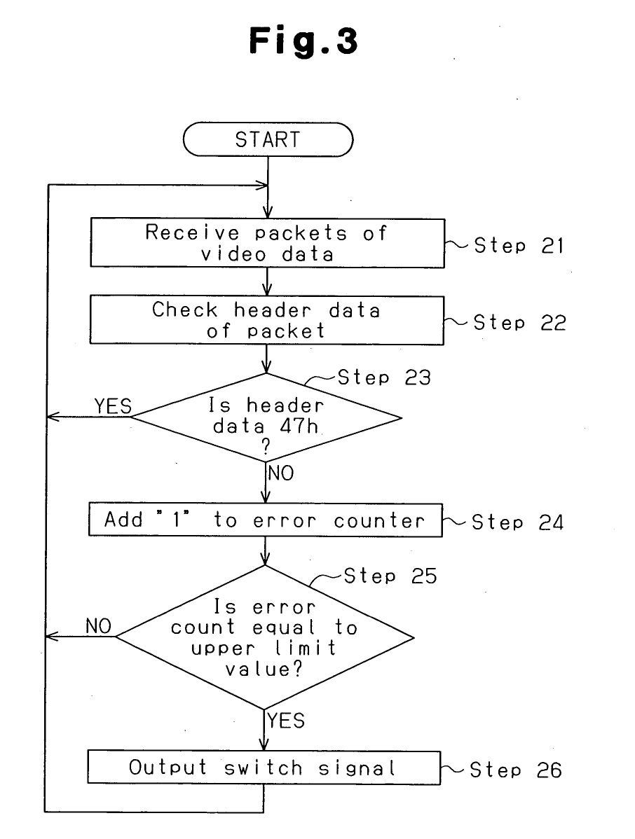

The error detection process performed by the video error detection circuit 12 will now be described with reference to FIG. 3.

The video error detection circuit 12 receives packets of video data from the decryption circuit 9a or from the decryption circuit 9b via the switch unit 10 (step S21) to checks the header data of the received packet (step S22). When checking the header data, the video error detection circuit 12 determines whether the header data is 47h (in which “h” indicates a hexadecimal number) (step S23).

When the header data has a value of 47h, the video error detection circuit 12 determines that the video data packet is normal, and the processing returns to step S21. When the header data does not have a value of 47h, the video error detection circuit 12 determines that an error has occurred in the decryption process. An error counter 12a included in the video error detection circuit 12 thus adds one to its count value (step S24). The video error detection circuit 12 determines whether the count value of the error counter 12a has reached a predetermined upper limit value (step S25). If the count value has not yet reached the upper limit value, the processing returns to step S21. When the count value of the error counter 12a reaches the upper limit value, a switch signal C is output to the switch unit 10 (step S26), and the processing returns to step S21.

The upper limit value used for the determination in step S25 is set by considering the influence of errors on the displayed video. More specifically, the upper limit value is set so that the connected decryption circuit is switched only when errors occur in many successive packets. The connected decryption circuit is not switched when errors occur in only a small number of packets because such errors would not have large influence on the video images that are shown.

The data transfer device 100 of the first embodiment has the advantages described below.

(1) The first and second channels for encrypting and decrypting video data using different keys transfer the same video data. When an error occurs during transfer of the data via the first channel, the transfer channel is switched from the first channel to the second channel. This seamlessly transfers the video data.

(2) When an error occurs in the first channel, the transfer channel is switched to the second channel and data is transferred via the second channel. Further, the first channel recovers to the normal state when the key updating process is successfully performed. Thus, if an error newly occurs in the second channel to which the transfer channel has been switched, the transfer channel is again switched from the second channel to the first channel. This seamlessly transfers the video data.

(3) Even if an error occurs in the decryption process performed by the receiver 6, the receiver 6 does not request transfer of a new key from the transmitter 1. Thus, the communication efficiency of the system is prevented from being lowered by such a transfer request for a new key.

### Second Embodiment

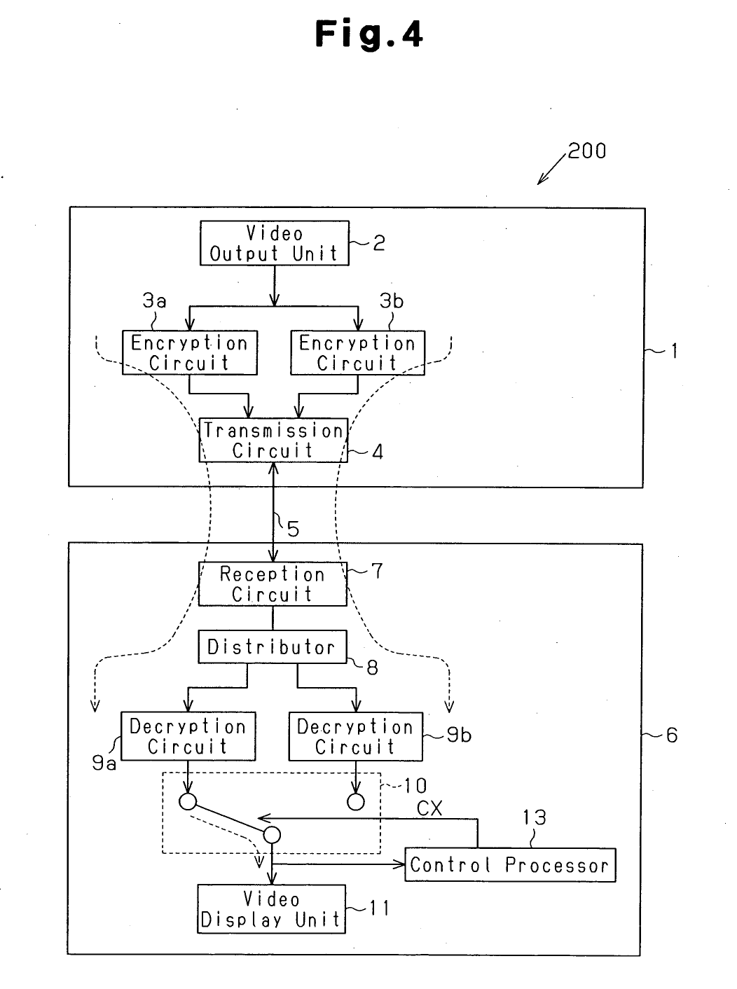

FIG. 4 shows a data transfer device 200 according to a second embodiment of the present invention. In the second embodiment, the video error detection circuit 12 of the first embodiment is replaced by a control processor 13.

The control processor 13 includes detection purpose software, which includes a program for detecting whether an error is contained in the video data. The control processor 13 receives video data in units of packets, performs the process of FIG. 3 in accordance with the software program, and outputs a switch signal CX to the switch unit 10.

With this configuration, the data transfer device 200 of the second embodiment has the same advantages as the advantages of the data transfer device 100 of the first embodiment.

### Third Embodiment

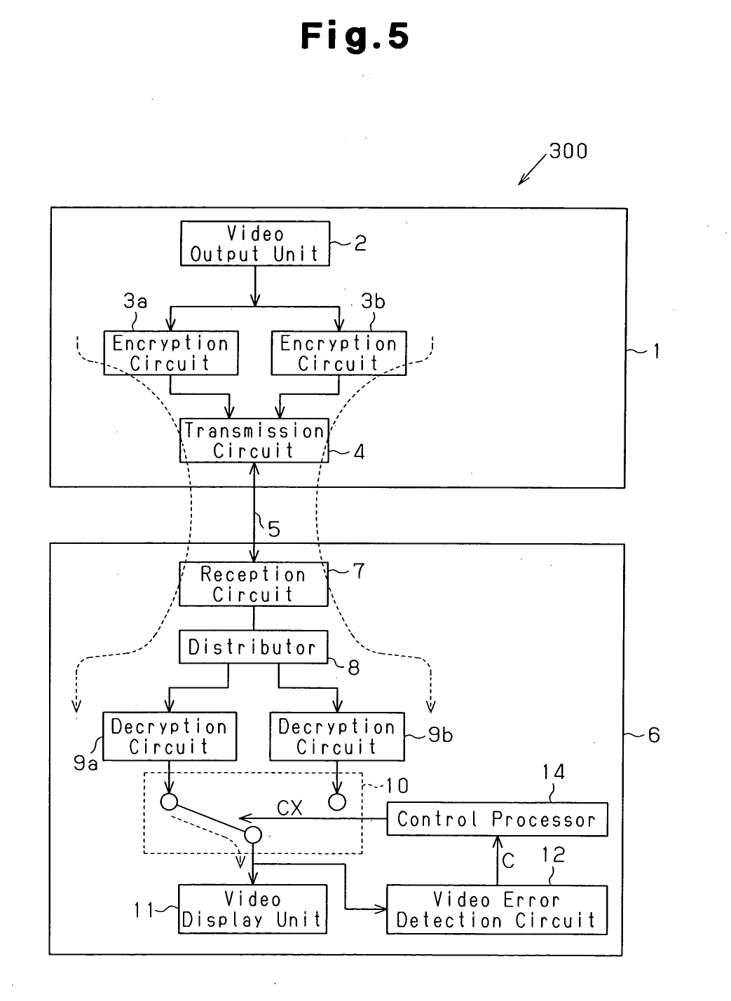

FIG. 5 shows a data transfer device 300 according to a third embodiment of the present invention. The data transfer device 300 of the third embodiment has the same configuration as the data transfer device 100 of the first embodiment except that a control processor 14 is added in the third embodiment.

The video error detection circuit 12 receives video data, performs the process of FIG. 3, and provides the control processor 14 with a switch signal C when detecting an error in the video data. The control processor 14 controls the operations of various circuits included in the receiver 6. In response to the switch signal C, the control processor 14 provides the switch unit 10 with a switch signal CX giving priority to this process over the other controls. In other words, the control processor 14 provides the switch unit 10 with a switch signal CX by generating an interrupt in response to the switch signal C. With this operation, the data transfer device 300 of the third embodiment has the same advantages as the advantages of the data transfer device 100 of the first embodiment.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

What is claimed is:

1. A data transfer device for transmitting and receiving encrypted data, the data transfer device comprising:
a transmitter for transmitting the data and a receiver for receiving the data, the transmitter and the receiver including a plurality of channels for transferring plural pieces of encrypted data that are generated by encrypting the same data using different keys and for decrypting the plural pieces of encrypted data;
the receiver further including a switch unit for selecting one of the plural pieces of decrypted data transferred via the plurality of channels and switching to the selected piece decrypted data based on a switch signal; and
an error detection unit for detecting an error in the selected decrypted data selected by the switch unit and generating the switch signal when detecting an error in the selected decrypted data.

2. The data transfer device according to claim 1, wherein the transmitter transmits the encrypted data to the receiver in packets, and the error detection unit detects errors in the decrypted data based on header data of each packet.

3. The data transfer device according to claim 2, wherein the error detection unit includes an error counter for counting errors, and generates the switch signal when a count value of the error counter exceeds a predetermined value.

4. The data transfer device according to claim 2, wherein the error detection unit is formed by an error detection circuit that includes the error counter and detects an error in the decrypted data based on the header data of each packet.

5. The data transfer device according to claim 2, wherein the error detection unit is formed by a control processor for performing a detection operation to detect errors in the decrypted data based on the header data of each packet, and a counting operation to count errors and generate the switch signal when a count value of the errors exceeds a predetermined value.

6. The data transfer device according to claim 2, wherein the error detection unit includes:
an error detection circuit, including the error counter, for detecting errors in the decrypted data based on the header data of each packet; and
a control processor for receiving the switch signal from the error detection circuit and providing the switch signal to the switch unit with priority over other processes.

7. A data transfer device for transmitting and receiving encrypted data, the data transfer device comprising:
a transmitter for transmitting the data and a receiver for receiving the data, the transmitter including a plurality of encryption circuits for generating plural pieces of encrypted data by encrypting the same data using different keys and appending a different channel number to each piece of encrypted data;
the receiver including:
a distributor for distributing the plural pieces of encrypted data in accordance with the channel number;
a plurality of decryption circuits for generating plural pieces of decrypted data by decrypting the plural pieces of encrypted data, wherein each decryption circuit decrypts the corresponding encrypted data distributed by the distributor based on a key transmitted from the corresponding encryption circuit;
a switch unit for selecting one of the plural pieces of decrypted data generated by the decryption circuits and switching to the selected decrypted data based on a switch signal; and
an error detection unit for detecting an error in the decrypted data selected by the switch unit and generating the switch signal when detecting an error.

8. The data transfer device according to claim 7, wherein the encryption circuits and the decryption circuits update the keys in predetermined time intervals.

9. The data transfer device according to claim 7, wherein each of the plurality of decryption circuits recovers to a state in which normal decryption is enabled by updating the keys after an error is detected in the decrypted data.

10. The data transfer device according to claim 7, wherein the transmitter transmits the encrypted data to the receiver in packets, and the error detection unit detects errors in the decrypted data based on header data of each packet.

11. The data transfer device according to claim 10, wherein the error detection unit includes an error counter for counting errors, and generates the switch signal when a count value of the error counter exceeds a predetermined value.

12. The data transfer device according to claim 10, wherein the error detection unit is formed by an error detection circuit that includes the error counter and detects an error in the decrypted data based on the header data of each packet.

13. The data transfer device according to claim 10, wherein the error detection unit is formed by a control processor for performing a detection operation to detect errors in the decrypted data based on the header data of each packet, and a counting operation to count errors and generate the switch signal when a count value of the errors exceeds a predetermined value.

14. The data transfer device according to claim 10, wherein the error detection unit includes:
an error detection circuit, including the error counter, for detecting errors in the decrypted data based on the header data of each packet; and
a control processor for receiving the switch signal from the error detection circuit and providing the switch signal to the switch unit with priority over other processes.

15. A data transfer device for transmitting and receiving encrypted data, the data transfer device comprising:
a transmitter for transmitting the data and a receiver for receiving the data, the transmitter including:
a first encryption circuit for encrypting data with a first key to generate first encrypted data; and
a second encryption circuit for encrypting data with a second key to generate second encrypted data;
the receiver including:
a first decryption circuit for receiving the first encrypted data from the first encryption circuit and decrypting the first encrypted data with the first key to generate first decrypted data;
a second decryption circuit for receiving the second encrypted data from the second encryption circuit and decrypting the second encrypted data with the second key to generate second decrypted data;
a switch unit, connected to the first and second decryption circuits, for selecting one of the first decrypted data and the second decrypted data and switching to the selected decrypted data based on a switch signal; and
an error detection unit, connected to the switch unit, for detecting an error in the decrypted data selected by the switch unit and generating the switch signal when detecting an error.
